(19) United States
(12) Patent Application Publication
(10) Pub. No.: US 2012/0176621 A1
(43) Pub. Date: Jul. 12, 2012

(54) GAS MIGRATION TEST METHOD

(76) Inventor: Kerruth George DOULL, Marwayne (CA)

(21) Appl. No.: 13/331,747

(22) Filed: Dec. 20, 2011

(30) Foreign Application Priority Data
Dec. 22, 2010 (CA) 2726154

(51) Int. Cl. G01N 21/00

(52) U.S. Cl. 356/437

(57) ABSTRACT

A method for performing a gas migration test in a test area surrounding a ground surface end of a wellbore, including providing an optical gas detector configured to selectively detect methane, establishing a pattern of test points including a plurality of test points at a ground surface in the test area, and using the optical gas detector at each of the test points to obtain an indication of methane concentration at each of the test points.

### TECHNICAL FIELD

A method for performing a gas migration test in a test area surrounding a ground surface end of a wellbore.

### BACKGROUND OF THE INVENTION

An oil and gas well typically includes a wellbore which extends into the ground from a ground surface end. A completed oil and gas well may include a wellhead, surface casing, production casing, and/or other structures, apparatus and/or equipment which are associated with the ground surface end of the wellbore.

Precautions are typically taken to prevent or inhibit “reservoir gases” from leaking from the wellbore via the production casing and/or via the space between the production casing and the surface casing. Leaking of reservoir gases from the wellbore via the production casing is sometimes described as “gas migration”, and may typically be detected in the soil surrounding the wellbore. Leaking of reservoir gases from the wellbore via the space between the production casing and the surface casing is sometimes described as “surface casing vent flow” and may typically be detected in the space between the production casing and the surface casing.

The reservoir gases which leak from a wellbore typically comprise methane and lesser amounts of heavier alkanes such as ethane, propane, butane and pentane and/or other hydrocarbons. Reservoir gases which leak from a wellbore are distinguishable from “biogenic gases”, which are produced by the natural decay and decomposition of organic material. Biogenic gases typically consist essentially of methane, but are typically present in relatively low methane concentrations in comparison with the methane concentrations which are typically observed in a leak of reservoir gases from a wellbore. Gas migration may be distinguished from the presence of background amounts of biogenic gases or methane from other sources by the detected methane concentration if the methane concentration can be determined with sufficient resolution and accuracy.

Gas migration may occur in producing wells or abandoned wells. Gas migration testing may be conducted in order to determine the presence and extent of gas migration.

In the Province of Alberta, Canada, Energy Resources Conservation Board (“ERCB”) Directive 020—Well Abandonment, dated June 2010 imposes a requirement that gas migration testing must be performed on certain wells which are abandoned or are scheduled for abandonment, and provides a recommendation that gas migration testing be performed on certain other wells prior to abandonment.

Gas migration testing is performed for the purpose of identifying anomalies in the composition of air or soil gases in the vicinity of the wellbore which may be indicative of gas migration. In general, a test of air or soil gases in the vicinity of the wellbore which provides a combustible material concentration of greater than 1 percent lower explosive limit (LEL) is considered to be indicative of gas migration.

ERCB Directive 020 further provides a suggested procedure for gas migration testing.

According to the suggested procedure, ground disturbance requirements described in the Alberta Pipeline Act and the Alberta Pipeline Regulation (AR 91/2005) must be followed in connection with gas migration testing. Pursuant to Part 5 of the Alberta Pipeline Regulation, no person shall undertake a ground disturbance in the vicinity of a pipeline (i.e., well) without the approval of either the licensee of the pipeline or the ERCB, or without properly preparing the area of the pipeline for the ground disturbance by locating and marking the pipeline.

Also according to the suggested procedure, gas migration testing is to be done only in frost-free months, and periods after a rainfall have to be avoided.

The suggested procedure provides a list of recommended equipment, which includes equipment capable of penetrating a minimum of 50 centimeters deep and a maximum of 64 millimeters in diameter, a calibrated explosion meter or other instrument capable of detecting hydrocarbon at 1 percent lower explosive limit (LEL), and equipment or material to seal a hole at surface while soil gases are being evacuated from the soil through the instrument.

The suggested procedure provides recommended test point locations, which include two test points within 30 centimeters of the wellbore on opposite sides, at 2 meter intervals outward from the wellbore every 90 degrees (a cross with the wellbore at center) to a distance of 6 meters, and at any points within 75 meters of the wellbore where there is apparent vegetation stress.

The suggested procedure provides recommended testing procedures, which include performing an instrument check (calibration, voltage, zero, etc.), making a hole a minimum of 50 centimeters deep, isolating the hole from atmospheric conditions, inserting a hose, wand or other equipment a minimum of 30 centimeters into the hole while maintaining a seal at surface to prevent atmospheric gas and soil gas from mixing, withdrawing a soil gas sample, recording observations, and purging the instrument and lines.

A combustible gas indicator (CGI) or explosion meter is based upon the principle of catalytic combustion of a gas sample and thus senses all combustible gases. Although recommended by the ERCB for performing gas migration testing, a combustible gas indicator (CGI) typically has a relatively low sensitivity and is generally unable to detect hydrocarbon levels much below the lower explosive limit (LEL). Because a combustible gas indicator (CGI) senses all combustible gases, it is not capable of selectively detecting methane.

A flame ionization detector (FID) is based upon the principle of measuring the electrical conductivity of a flame while burning carbon compounds in a gas sample and thus senses all combustible gases. A flame ionization detector (FID) is capable of detecting gas concentration in parts per million and therefore typically has a relatively higher sensitivity than a combustible gas indicator (CGI). Because a flame ionization detector (FID) senses all combustible gases, it is not capable of selectively detecting methane.

As indicated above in connection with the ERCB suggested procedure for gas migration testing, a combustible gas indicator (CGI) or explosion meter is known for performing a gas migration test in accordance with ERCB Directive 020, and is in fact equipment which is recommended by the ERCB for performing gas migration testing.

There remains a need for a gas migration test method which is capable of selectively detecting methane, which is capable of detecting methane concentrations at relatively low parts per million (ppm), which does not require the formation of ground disturbances, and which is substantially similar and/or equivalent to the suggested procedure outlined in ERCB Directive 020.

### SUMMARY OF THE INVENTION

References in this document to orientations, to operating parameters, to ranges, to lower limits of ranges, and to upper limits of ranges are not intended to provide strict boundaries for the scope of the invention, but should be construed to mean “approximately” or “about” or “substantially”, within the scope of the teachings of this document, unless expressly stated otherwise.

The present invention is a method for performing a gas migration test in a test area surrounding a ground surface end of a wellbore using an optical gas detector. The gas migration test method of the invention selectively detects methane using the optical gas detector in order to obtain an indication of methane concentration representing gas migration of reservoir gases from the wellbore and/or the presence of biogenic gases or methane from other sources in the vicinity of the wellbore.

Because of the use of an optical gas detector in the method, the gas migration test method of the invention does not require the formation or ground disturbances as contemplated in ERCB Directive 020, because an optical gas detector is capable of reasonably effectively and reasonably accurately obtaining indications of methane concentration which are representative of gas migration and/or the presence of biogenic gases by analyzing air samples obtained at the ground surface without disturbing the ground surface.

As used herein, “at the ground surface without disturbing the ground surface” means in contact with or adjacent to the ground surface without causing any significant disturbance of the ground surface.

The optical gas detector may be comprised of any device or apparatus which is capable of being configured to detect absorption of light by methane. In some embodiments the optical gas detector may be comprised of a portable optical gas detector. In some embodiments, the optical gas detector may be comprised of an open path gas detector. In some embodiments, the optical gas detector may be comprised of a closed path gas detector which comprises a detection chamber for containing a gas sample to be analyzed.

In an exemplary aspect, the present invention is a method for performing a gas migration test in a test area surrounding a ground surface end of a wellbore, the method comprising:
(a) providing an optical gas detector configured to selectively detect methane;
(b) establishing a pattern of test points at a ground surface in the test area, wherein the pattern of test points is comprised of a plurality of test points; and
(c) using the optical gas detector at each of the test points to obtain an indication of methane concentration at each of the test points.

In some embodiments, the optical gas detector may be configured as a closed path gas detector and may therefore be comprised of a detection chamber for containing a gas sample to be analyzed, a light source in communication with the detection chamber for emitting light, a light detector in communication with the detection chamber for receiving light emitted by the light source, a light path extending through the detection chamber between the light source and the light detector, and a sample probe in communication with the detection chamber for obtaining the gas sample. In some embodiments, the optical gas detector may be further comprised of a pump or other suitable device or apparatus for delivering the gas sample from the sample probe to the detection chamber.

In some embodiments in which the optical gas detector may be configured as a closed path gas detector, obtaining the indication of methane concentration may be comprised of obtaining with the sample probe a test point air sample as the gas sample at the ground surface without disturbing the ground surface, delivering the test point air sample from the sample probe to the detection chamber, and measuring an absorption of light emitted by the light source by the test point air sample along the light path.

In some embodiments, the optical gas detector may be configured as an open path gas detector (OPGD) and may therefore not include the detection chamber and/or the sample probe.

In some embodiments in which the optical gas detector may be configured as an open path gas detector, obtaining the indication of methane concentration may be comprised of establishing a light path between the light source and the light detector through an ambient test point air sample, emitting light from the light source along the light path, and measuring an absorption of light emitted by the light source by the test point air sample along the light path.

In some embodiments, the optical gas detector may operate in the infrared region of the electromagnetic spectrum so that the optical gas detector may be an infrared (IR) gas detector.

In some embodiments, the optical gas detector may be a non-dispersive infrared (NDIR) detector. In some embodiments the optical gas detector may be a laser based infrared detector.

In some embodiments, the optical gas detector may be configured to selectively detect absorption of infrared light having a wavelength which is characteristic of methane. In some embodiments, the optical gas detector may be configured to selectively detect absorption of infrared light having a wavelength of about 3.4 micrometers.

The pattern of test points may be comprised of any arrangement or pattern which is capable of facilitating providing an indication of gas migration from the wellbore.

In some embodiments, the pattern of test points may be centered on the ground surface end of the wellbore so that the pattern of test points extends from the ground surface end of the wellbore.

The pattern of test points may be comprised of any number of test points.

In some embodiments, the pattern of test points may be comprised of a square or rectangular pattern. In some embodiments, the pattern of test points may be comprised of any number of test points spaced circumferentially around any number of progressively larger squares or rectangles extending from the ground surface end of the wellbore. The test points may be spaced evenly or unevenly around the circumference of the squares or rectangles.

In some embodiments, the pattern of test points may be comprised of an oval pattern. In some embodiments, the pattern of test points may be comprised of any number of test points spaced circumferentially around any number of progressively larger ovals extending from the ground surface end of the wellbore. The test points may be spaced evenly or unevenly around the circumference of the ovals.

In some embodiments, the pattern of test points may be comprised of a circular pattern. In some embodiments, the pattern of test points may be comprised of any number of test points spaced circumferentially around any number of progressively greater radii extending from the ground surface end of the wellbore. The test points may be spaced evenly or unevenly around the circumference of the radii.

In some embodiments, the pattern of test points may be comprised of a plurality of test points spaced circumferentially around a first radius extending from the ground surface end of the wellbore. In some embodiments, the plurality of test points spaced circumferentially around the first radius may consist of four first radius test points. In some embodiments, the first radius test points may be spaced circumferentially by about 90 degrees so that the first radius test points are substantially evenly spaced.

In some embodiments, the pattern of test points may be further comprised of a plurality of test points spaced circumferentially around a second radius extending from the ground surface end of the wellbore, wherein the second radius is greater than the first radius. In some embodiments, the plurality of test points spaced circumferentially around the second radius may consist of four second radius test points. In some embodiments, the second radius test points may be spaced circumferentially by about 90 degrees so that the second radius test points are substantially evenly spaced.

In some embodiments, the pattern of test points may be further comprised of a plurality of test points spaced circumferentially around a third radius extending from the ground surface end of the wellbore, wherein the third radius is greater than the second radius. In some embodiments, the plurality of test points spaced circumferentially around the third radius may consist of four third radius test points. In some embodiments, the third radius test points may be spaced circumferentially by about 90 degrees so that the third radius test points are substantially evenly spaced.

In some embodiments, the first radius test points, the second radius test points and/or the third radius test points may be arranged along substantially straight lines extending from the ground surface end of the wellbore, so that the test points are not offset circumferentially relative to each other. This arrangement, however, will result in large sections of the test area having no test points.

In some embodiments, the second radius test points may be offset from the first radius test points. In some embodiments, the second test points may be offset from the first radius test points by about 45 degrees. In some embodiments, the third radius test points may be offset from the second radius test points. In some embodiments, the third test points may be offset from the second radius test points by about 45 degrees. Offsetting the test points will reduce the size of the sections of the test area which have no test points and will generally provide more even coverage of the test area by the test points.

The first radius, the second radius and the third radius may be any distance. In some embodiments, the first radius, the second radius and the third radius may increase by a common increment. In some embodiments, the first radius, the second radius and/or the third radius may increase by different increments. In some embodiments, the first radius may be about 1 meter. In some embodiments, the first radius may be about 2 meters. In some embodiments, the second radius may be about 2 meters. In some embodiments, the second radius may be about 4 meters. In some embodiments, the third radius may be about 3 meters. In some embodiments, the third radius may be about 6 meters.

In some embodiments, the pattern of test points may be further comprised of one or more adjacent test points located adjacent to the ground surface end of the wellbore. In some embodiments, the one or more test points located adjacent to the ground surface of the wellbore may consist of two adjacent test points. In some embodiments, the adjacent test points may be located within about 30 centimeters of the ground surface end of the wellbore. In some embodiments, two adjacent test points may be located on opposite sides of the ground surface end of the wellbore.

In some embodiments, the pattern of test points may be arranged according to the recommended test point locations which are described in the suggested procedure for gas migration testing in ERCB Directive 020.

### BRIEF DESCRIPTION OF DRAWINGS

Embodiments of the invention will now be described with reference to the accompanying drawings, in which:

FIG. 1 is a schematic drawing of a pattern of test points according to an exemplary embodiment of the method of the invention.

FIG. 2 is a schematic drawing of some basic components of a type of optical gas detector which is suitable for use in the method of the invention.

### DETAILED DESCRIPTION

The present invention is a method for performing a gas migration test in a test area surrounding a ground surface end of a wellbore.

The gas migration test method may be performed in association with abandonment of a well comprising the wellbore, or the gas migration test method may be performed in association with the ongoing operation and management of a well comprising the wellbore. The gas migration test method is particularly suited for use in performing gas migration testing as described in ERCB Directive 020, which is applicable to the performance of gas migration testing in the Province of Alberta, Canada.

Gas migration testing in the Province of Alberta typically involves obtaining an indication of the concentration of combustible gases at different test point locations in a pattern of test points in a test area surrounding a ground surface end of a wellbore. Conventionally, gas migration testing is typically performed using a combustible gas indicator (CGI) or explosion meter, or in some cases using a flame ionization detector (FID). A suggested procedure for performing gas migration testing is described in ERCB Directive 020.

Conventionally, gas migration testing is relatively labour intensive and time consuming. At each test point location, a hole about 50 centimeters deep and as large as 64 millimeters in diameter must be made in the ground, the hole must be isolated from atmospheric conditions, a hose or wand must be inserted into the hole while maintaining a seal at the ground surface to prevent atmospheric gas and soil gas from mixing, a soil gas sample must be obtained from the hole, and the soil gas sample must be analyzed to obtain an indication of the concentration of the combustible gases in the soil gas sample.

The conventional procedure for performing gas migration testing which is typically followed in the Province of Alberta requires compliance with the ground disturbance requirements which are set out in the Alberta Pipeline Act and the Alberta Pipeline Regulation. Pursuant to Part 5 of the Alberta Pipeline Regulation, approval of either the licensee of the pipeline (i.e., well) or of the ERCB must be obtained before undertaking a ground disturbance in the vicinity of the pipeline. In addition, the area of the pipeline must be properly prepared for the ground disturbance by locating and marking the pipeline. These ground disturbance requirements, although necessary and prudent, can result in a significant delay before gas migration testing can be performed.

In addition, the conventional procedure for gas migration testing which is typically followed in the Province of Alberta typically cannot be performed when frost is in the ground or immediately after a rainfall. In addition, rocks, muskeg and other challenging terrain may make the conventional procedure for gas migration testing difficult if not impossible to perform.

The present invention is based upon the discovery that the use of an optical gas detector to perform a gas migration test method in a manner which is similar and/or equivalent to the suggested procedure which is described in ERCB Directive 020 provides several advantages over a gas migration test method which is performed using either a combustible gas indicator (CGI) or a flame ionization detector (FID).

A first advantage of using an optical gas detector is that an optical gas detector is capable of selectively detecting methane without detecting other hydrocarbons and combustible materials.

A second advantage of using an optical gas detector is that an optical gas detector is capable of detecting methane concentration in parts per million and therefore has a relatively higher sensitivity and/or resolution than a combustible gas indicator (CGI). This relatively higher sensitivity and/or resolution enables an optical gas detector to distinguish in many circumstances gas migration of reservoir gases from background levels of biogenic gases or methane from other sources, and/or enables an optical gas detector to detect and quantify ambient concentrations of methane in the air or atmosphere above the ground surface, which may be indicative of gas migration of reservoir gases, background levels of biogenic gases, or methane from other sources.

A third advantage of using an optical gas detector is that it has been discovered that an optical gas detector is capable of providing reasonably reliable and reasonably accurate indications of methane concentration at test point locations without the need to form holes and thus comply with the ground disturbance requirements in the Alberta Pipeline Act and Pipeline Regulation. This third advantage provides significant time and cost savings in performing a gas migration test.

A fourth advantage of using an optical gas detector is that an optical gas detector can be used in virtually any and all weather conditions and in virtually any and all terrain, in part because no holes need to be formed at the test point locations.

An optical gas detector is based upon the principle that a substance may absorb light selectively at one or more wavelengths in the electromagnetic spectrum. An optical gas detector typically includes a light source and a light detector. Light from the light source is passed through a gas sample and then detected by the light detector. The amount of light absorbed by the gas sample can be determined from the strength of the light signal which is detected by the light detector.

Methane exhibits absorption of infrared light at a number of different wavelength absorption bands, including wavelengths of about 1.3 micrometers, about 1.7 micrometers, about 3.4 micrometers, and about 7.6 micrometers. Outside of the relatively narrow wavelength absorption bands, methane absorbs very little light.

Any optical gas detector which is capable of selectively detecting methane may be used in the method of the invention. Since methane exhibits absorption of light at a number of different wavelength absorption bands within the infrared region of the electromagnetic spectrum, an optical gas detector which is suitable for use in the invention operates in the infrared region of the electromagnetic spectrum, and is configured to selectively detect absorption of infrared light having a wavelength which is characteristic of methane. As a result, an optical gas detector which is suitable for use in the invention may be described as an infrared (IR) gas detector.

Several different types of optical gas detector may therefore be suitable for use in the method of the invention.

A first type of suitable optical gas detector includes a light source which produces light which is not limited to a particular wavelength. This type of optical gas detector includes one or more filters which process the light which is produced by the light source so that only a desired wavelength or range of wavelengths is allowed to be detected by the light detector. An exemplary apparatus according to this first suitable type of optical gas detector is a non-dispersive infrared (NDIR) detector.

As a non-limiting example, a suitable non-dispersive infrared (NDIR) detector for use in the method of the invention may be a Sensit™ PMD methane detector, which is manufactured by Sensit Technologies in Valparaiso, Ind., USA.

A second type of suitable optical gas detector includes a light source which produces light which is limited to a desired wavelength or range of wavelengths. An exemplary apparatus according to this second suitable type of optical gas detector is a laser based infrared detector.

Laser based infrared detectors are described by many different names and acronyms. Any laser based infrared detector which is capable of selectively detecting methane may be used in the method of the invention. As non-limiting examples, a laser based infrared detector which may be suitable for use in the method of the invention may be described as a laser gas detector (LGD), a tunable diode laser (TDL) detector, a diffracted feedback (DFB) laser diode detector, a laser diode (LD) detector, a laser spectrometer, a laser absorption spectrometry (LAS) detector, a direct laser absorption spectrometry (DLAS) detector, a tunable diode laser absorption spectrometry (TDLAS) detector, or may be known by some other name and/or acronym.

As non-limiting examples, suitable laser based infrared detectors for use in the method of the invention may be a Sensi™ LMD laser methane detector manufactured by Sensit Technologies of Valparaiso, Ind., USA and a '46 Hawk™ methane detector manufactured by Southern Cross Corp. of Norcross, Ga., USA.

The optical gas detector may be configured to selectively detect absorption of any wavelength or wavelengths of infrared light which is characteristic of methane, such as about 1.3 micrometers, about 1.7 micrometers, about 3.4 micrometers, and about 7.6 micrometers. A wavelength of about 3.4 micrometers may encounter a reduced amount of interference with other forms of electromagnetic energy than other wavelengths which may be characteristic of methane. As a result, an optical gas detector which is configured to selectively detect absorption of infrared light having a wavelength of about 3.4 micrometers may be particularly suited for use in the method of the invention.

An optical gas detector may be configured as an open path gas detector (OPGD) or as a closed path gas detector.

In an open path gas detector (OPGD), the light from the light source travels outside of the detector apparatus through an ambient gas plume and is either detected by a remote light detector or reflected back to a light detector in the detector apparatus. An open path gas detector therefore provides an indication of gas concentration along the entire light path travelled by the light, which indication is essentially an integral of the gas detected along the light path. An open path gas detector does not typically include a detection chamber within the detector apparatus.

A closed path gas detector typically comprises a detection chamber for containing a gas sample to be analyzed. The light source and the light detector are both in communication with the detection chamber, and a light path extends through the detection chamber between the light source and the light detector. The light path may include one or more mirrors or other type of light reflector for repeatedly directing the light between ends of the detection chamber in order to lengthen the light path and provide a multi-pass detection chamber. A closed path gas detector also typically comprises a sample probe in communication with the detection chamber for obtaining the gas sample, and a pump or other suitable device or apparatus for delivering the gas sample from the sample probe to the detection chamber.

Although an open path gas detector may be used in the method of the invention, a closed path gas detector may be more suitable for use in the method of the invention because a closed path gas detector is capable of analyzing a discrete test point air sample which is obtained at a discrete test point location.

In summary, the method of the invention may be performed using an optical gas detector which is configured to operate in the infrared region of the electromagnetic spectrum an infrared gas detector). The infrared gas detector may be comprised of any type of infrared gas detector which is capable of selectively detecting methane, including but not limited to a non-dispersive infrared (NDIR) detector or a laser based infrared detector, and the infrared detector may be comprised of either an open path gas detector or a closed path gas detector.

The method of the invention may be performed in a manner similar to a conventional gas migration test procedure, including the suggested gas migration testing procedure set out in ERCB Directive 020.

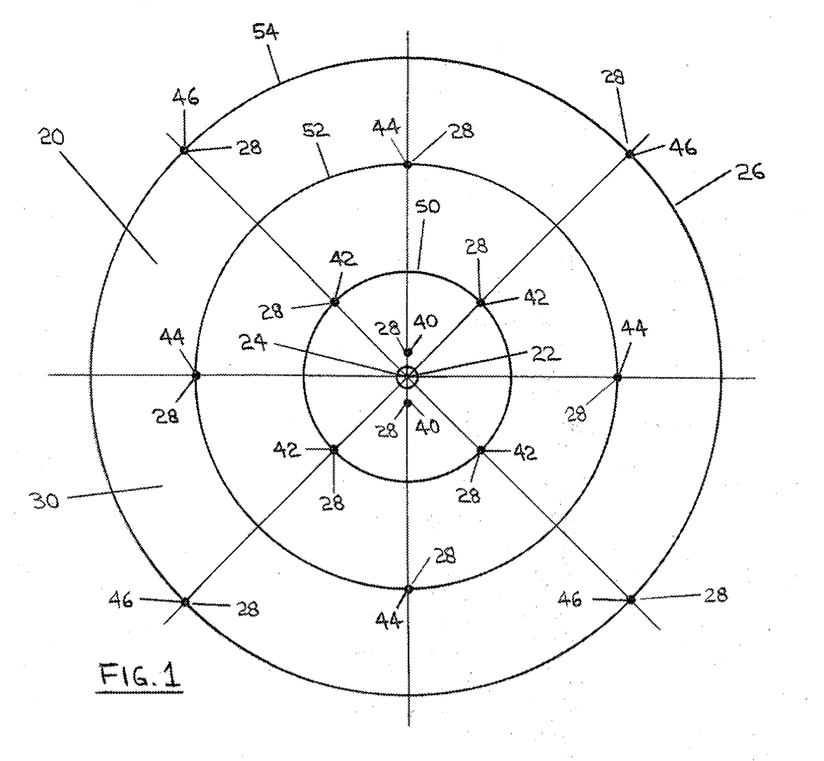

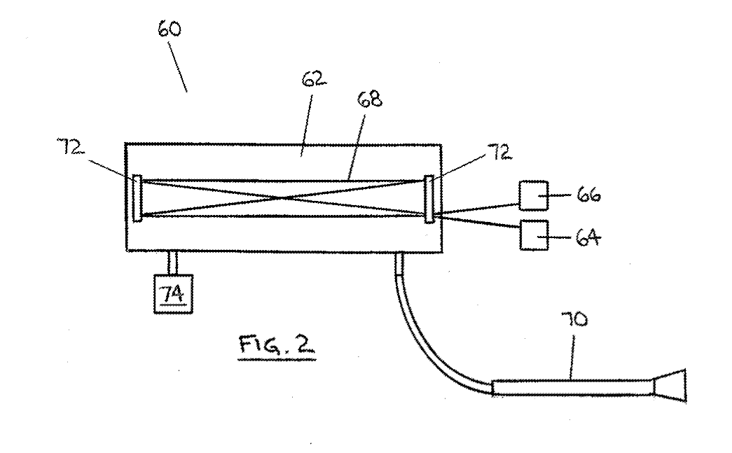

Referring to FIGS. 1-2, an exemplary embodiment of the gas migration test method of the invention may be performed as follows.

In the embodiment of FIGS. 1-2, the gas migration test method is performed in a test area (20) surrounding a ground surface end (22) of a wellbore (24).

In the embodiment of FIGS. 1-2, a pattern (26) of test points (28) is established at a ground surface (30) in the test area (20). As depicted in FIG. 1, the pattern (26) of test points (28) is comprised of two adjacent test points (40), four first radius test points (42), four second radius test points (44) and four third radius test points (46).

The two adjacent test points (40) are located within about 30 centimeters of the ground surface end (22) of the wellbore (24) and are located on opposite sides of the ground surface end (22) of the wellbore (24).

The four first radius test points (42) are spaced circumferentially by about 90 degrees around a first radius (50) extending from the ground surface end (22) of the wellbore (24). The first radius (50) is about 2 meters.

The four second radius test points (44) are spaced circumferentially by about 90 degrees around a second radius (52) extending from the ground surface end (22) of the wellbore (24). The second radius (52) is about 4 meters. The four second radius test points (44) are offset from the first radius test points (42) by about 45 degrees.

The four third radius test points (46) are spaced circumferentially by about 90 degrees around a third radius (54) extending from the ground surface end (22) of the wellbore (24). The third radius (54) is about 6 meters. The four third radius test points (46) are offset from the second radius test points (44) by about 45 degrees.

In the embodiment of FIGS. 1-2, the gas migration test method is performed using an optical gas detector (60) which is configured to selectively detect methane. Referring to FIG. 2, the optical gas detector (60) is comprised of a detection chamber (62) for containing a gas sample to be analyzed, a light source (64) in communication with the detection chamber (62) for emitting light, a light detector (66) in communication with the detection chamber (62) for receiving light emitted by the light source (64), a light path (68) extending through the detection chamber (62) between the light source (64) and the light detector (66), and a sample probe (70) in communication with the detection chamber (62) for obtaining the gas sample. Mirrors (72) are provided in the detection chamber (62) to lengthen the light path (68) within the detection chamber (62). The optical gas detector (60) is further comprised of a pump (74) or some other suitable device or apparatus for delivering the gas sample from the sample probe (70) to the detection chamber (62).

Depending upon the type of optical gas detector which is used in the method of the invention, the optical gas detector (60) may be further comprised of one or more filters (not shown) for filtering the light emitted by the light source (64) to provide light having a desired wavelength or range of wavelengths.

In the embodiment of FIGS. 1-2, the general configuration of the optical gas detector (60) may be generally similar to that of the optical gas detector which is described in U.S. Pat. No. 7,710,568 (Paige et al). In the embodiment of FIGS. 1-2, a Sensit™ PMD methane detector as an NDIR detector, and a Sensit™ LMD laser methane detector as a laser based infrared detector are both suitable for use in performing the method.

In the embodiment of FIGS. 1-2, the optical gas detector (60) is used at each of the test points (28) to obtain an indication of methane concentration at each of the test points (28).

In the embodiment of FIGS. 1-2, obtaining the indication of methane concentration at each of the test points (28) is comprised of obtaining with the sample probe (70) a test point air sample as a gas sample to be analyzed by the optical gas detector (60). The test point air sample is obtained at the ground surface (30) without disturbing the ground surface (30).

In the embodiment of FIGS. 1-2, obtaining the test point air sample at the ground surface (30) is comprised of obtaining the test point air sample at or as close to the ground surface (30) as is practicable, without causing any significant disturbance in the ground surface (30).

In the embodiment of FIGS. 1-2, the test point air sample is analyzed by the optical gas detector (60) by measuring an absorption of light emitted by the light source (64) by methane contained in the test point air sample. In the embodiment of FIGS. 1-2, the absorption of light by methane contained in the test point air sample may be measured by comparing the energy of light which has passed through the test point air sample with the energy of light in a reference light beam which has not passed through the test point air sample, or may be measured in any other manner facilitated by the optical gas detector (60).

Testing of the method of the invention has demonstrated a number of specific advantages of the gas migration test method of the invention over conventional gas migration test methods.

First, the method of the invention is capable of detecting and quantifying methane concentration in some circumstances with a sensitivity or resolution of less than about 1 part per million (ppm), which is a far greater sensitivity or resolution than that provided by a combustible gas indicator (CGI). Furthermore, both the Sensit™ PMD methane detector and the Sensit™ LMD laser methane detector are capable of converting methane concentrations in ppm to methane concentrations which are expressed as either percent lower explosive limit (LEL) or percent volume.

Second, the method of the invention is capable of providing a reasonably reliable and reasonably accurate indication of methane concentration at virtually any surface which is exposed to a constant methane source, including the surfaces of frozen, wet, dry or rocky soils, and at ice, concrete and wooden surfaces.

Third, the method of the invention allows gas migration testing to be conducted in virtually all seasons arid conditions and in virtually all soil media (eg., earth, rock, bentonite, muskeg, etc.) because optical gas detectors are capable of detecting absorption of methane by soil media in virtually all conditions.

Fourth, the method of the invention is quick and efficient to perform in comparison with conventional gas migration testing which requires the formation of holes at each test point, with the result that either a gas migration test may be completed more quickly or that a gas migration test may be conducted with an increased number of test points.

Fifth, the method of the invention is capable of efficiently identifying peak methane concentration anomalies during testing so that the selection of test points and the test pattern can be optimized.

Sixth, the method of the invention avoids the costs and delays associated with complying with the ground disturbance requirements of the Alberta Pipeline Act and the Alberta Pipeline Regulation, including approvals and the locating and marking of wellbores.

Seventh, the method of the invention is capable of generating base level data regarding the background concentration of biogenic gases or methane from other sources in the vicinity of a wellbore because of the relatively high sensitivity and resolution of the optical gas detector, which facilitates detection of the relatively low concentration of biogenic gases or methane from other sources which is typically encountered.

Eighth, the method of the invention is capable in some circumstances of distinguishing between methane concentration due to reservoir gases and methane concentration due to biogenic gases or methane from other sources, because of the relatively high sensitivity and resolution of the optical gas detector, which facilitates differentiating methane concentrations of less than about 100 ppm (which are typical of background levels of biogenic gases or methane from other sources) with higher methane concentrations which are typical of gas migration.

Ninth, the method of the invention is capable in some circumstances of distinguishing between methane concentration due to above grade sources of methane (such as wellheads and related wellsite surface infrastructure) and methane concentration due to below grade sources of methane (such as biogenic gases, gas migration of reservoir gases and wellbore/pipeline failures).

In addition, the use of an optical gas detector in the method of the invention enables the detection and quantification of ambient concentrations of methane in the air or atmosphere above the ground surface. Depending upon the ambient concentration of methane which is detected by the optical gas detector, it may be possible to identify the likely source of the methane (i.e., gas migration, biogenic gases, or methane from other sources) before performing the method of the invention, or to use the detected ambient concentration to confirm or verify the results of the method of the invention.

In this document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be one and only one of the elements.

The embodiments of the invention in which an exclusive property or privilege is claimed are defined as follows:

1. A method for performing a gas migration test in a test area surrounding a ground surface end of a wellbore, the method comprising:
(a) providing an optical gas detector configured to selectively detect methane;
(b) establishing a pattern of test points at a ground surface in the test area, wherein the pattern of test points is comprised of a plurality of test points; and
(c) using the optical gas detector at each of the test points to obtain an indication of methane concentration at each of the test points.

2. The method as claimed in claim 1 wherein the optical gas detector is comprised of a detection chamber for containing a gas sample to be analyzed, a light source in communication with the detection chamber for emitting light, a light detector in communication with the detection chamber for receiving light emitted by the light source, a light path extending through the detection chamber between the light source and the light detector, and a sample probe in communication with the detection chamber for obtaining the gas sample, and wherein obtaining the indication of methane concentration at each of the test points is comprised of obtaining with the sample probe a test point air sample as the gas sample at the ground surface without disturbing the ground surface, delivering the test point air sample from the sample probe to the detection chamber, and measuring an absorption of light emitted by the light source by the test point air sample along the light path.

3. The method as claimed in claim 2 wherein the pattern of test points is comprised of a plurality of test points spaced circumferentially around a first radius extending from the ground surface end of the wellbore.

4. The method as claimed in claim 3 wherein the pattern of test points is further comprised of a plurality of test points spaced circumferentially around a second radius extending from the ground surface end of the wellbore, and wherein the second radius is greater than the first radius.

5. The method as claimed in claim 4 wherein:
(a) the plurality of test points spaced circumferentially around the first radius consists of four first radius test points, and wherein the first radius test points are spaced circumferentially by 90 degrees; and
(b) the plurality of test points spaced circumferentially around the second radius consists of four second radius test points, and wherein the second radius test points are spaced circumferentially by 90 degrees.

6. The method as claimed in claim 5 wherein the second radius test points are offset from the first radius test points by 45 degrees.

7. The method as claimed in claim 4 wherein the first radius is 1 meter and wherein the second radius is 2 meters.

8. The method as claimed in claim 4 wherein the pattern of test points is further comprised of a plurality of test points spaced circumferentially around a third radius extending from the ground surface end of the wellbore, and wherein the third radius is greater than the second radius.

9. The method as claimed in claim 8 wherein:
(a) the plurality of test points spaced circumferentially around the first radius consists of four first radius test points, and wherein the first radius test points are spaced circumferentially by 90 degrees:
(b) the plurality of test points spaced circumferentially around the second radius consists of four second radius test points, and wherein the second radius test points are spaced circumferentially by 90 degrees; and
(c) the plurality of test points spaced circumferentially around the third radius consists of four third radius test points, and wherein the third radius test points are spaced circumferentially by 90 degrees.

10. The method as claimed in claim 9 wherein the second radius test points are offset from the first radius test points by 45 degrees and wherein the third radius test points are offset from the second radius test points by 45 degrees.

11. The method as claimed in claim 8 wherein the first radius is 1 meter, the second radius is 2 meters, and the third radius is 3 meters.

12. The method as claimed in claim 9 wherein the pattern of test points is further comprised of a plurality of test points located adjacent to the ground surface end of the wellbore.

13. The method as claimed in claim 12 wherein the plurality of test points located adjacent to the ground surface end of the wellbore consists of two adjacent test points.

14. The method as claimed in claim 12 wherein the first radius is 2 meters, wherein the second radius is 4 meters, and wherein the third radius is 6 meters.

15. The method as claimed in claim 14 wherein the second radius test points are offset from the first radius test points by 45 degrees, and wherein the third radius test points are offset from the second radius test points by 45 degrees.

16. The method as claimed in claim 2 wherein the optical gas detector operates in the infrared region of the electromagnetic spectrum.

17. The method as claimed in claim 16 wherein the optical gas detector is configured to selectively detect absorption of infrared light having a wavelength which is characteristic of methane.

18. The method as claimed in claim 17 wherein the optical gas detector is a non-dispersive infrared detector.

19. The method as claimed in claim 18 wherein the optical gas detector is configured to selectively detect absorption of infrared light having a wavelength of about 3.4 micrometers.

20. The method as claimed in claim 17 wherein the optical gas detector is a laser based infrared detector comprising a laser as the light source.

21. The method as claimed in claim 20 wherein the optical gas detector is configured to selectively detect absorption of infrared light having a wavelength of about 3.4 micrometers.

22. A method for performing a gas migration test in a test area surrounding a ground surface end of a wellbore, the method comprising:
(a) providing an optical gas detector configured to selectively detect methane;
(b) establishing a pattern of test points at a ground surface in the test area, wherein the pattern of test points is comprised of a plurality of test points;
(c) using the optical gas detector at each of the test points without disturbing the ground surface to obtain an indication of methane concentration at each of the test points;
(d) using the optical gas detector to detect and quantify an ambient concentration of methane in an atmosphere above the ground surface; and
(e) comparing the indication of methane concentration at each of the test points with the ambient concentration of methane in the atmosphere above the ground surface in order to distinguish gas migration from biogenic gases or methane from other sources.

23. In a gas migration test performed in a test area surrounding a ground surface end of a wellbore, a method comprising:
(a) providing an optical gas detector configured to selectively detect methane;
(b) using the optical gas detector to obtain a test point air sample at a ground surface at each of a plurality of test points in the test area to obtain an indication of methane concentration at each of the test points;
(c) using the optical gas detector to detect and quantify an ambient concentration of methane in an atmosphere above the ground surface; and
(d) comparing the indication of methane concentration at each of the test points with the ambient concentration of methane in the atmosphere above the ground surface in order to distinguish gas migration from biogenic gases or methane from other sources.

24. The method as claimed in claim 23 wherein the optical gas detector is comprised of a detection chamber for containing a gas sample to be analyzed, a light source in communication with the detection chamber for emitting light, a light detector in communication with the detection chamber for receiving light emitted by the light source, a light path extending through the detection chamber between the light source and the light detector, and a sample probe in communication with the detection chamber for obtaining the gas sample, and wherein obtaining the indication of methane concentration at each of the test points is comprised of obtaining with the sample probe the test point air sample as the gas sample, delivering the test point air sample from the sample probe to the detection chamber, and measuring an absorption of light emitted by the light source by the test point air sample along the light path.

25. The method as claimed in claim 24 wherein the plurality of test points is comprised of a plurality of test points spaced circumferentially around a first radius extending from the ground surface end of the wellbore.

26. The method as claimed in claim 25 wherein the plurality of test points is further comprised of a plurality of test points spaced circumferentially around a second radius extending from the ground surface end of the wellbore, and wherein the second radius is greater than the first radius.

27. The method as claimed in claim 26 wherein the plurality of test points is further comprised of a plurality of test points spaced circumferentially around a third radius extending from the ground surface end of the wellbore, and wherein the third radius is greater than the second radius.

28. The method as claimed in claim 27 wherein the plurality of test points is further comprised of a plurality of test points located adjacent to the ground surface end of the wellbore.
